(19) United States
(12) Patent Application Publication
(10) Pub. No.: US 2022/0297472 A1
(43) Pub. Date: Sep. 22, 2022

(54) WHEEL RIM ASSEMBLY

(71) Applicant: ADVANCED INTERNATIONAL MULTITECH CO., LTD., Kaohsiung City (TW)

(72) Inventors: Te-Fu HSIAO, Kaohsiung City (TW); Che-Hao KUO, Kaohsiung City (TW); Chung-Hsin CHANG, Kaohsiung City (TW); Chia-Hsin WANG, Kaohsiung City (TW)

(21) Appl. No.: 17/337,773

(22) Filed: Jun. 3, 2021

(30) Foreign Application Priority Data
Mar. 16, 2021 (TW) 110109351

(51) Int. Cl. B60B 3/04; B60B 3/10; B60B 3/14; B60B 3/00

(52) U.S. Cl. CPC B60B 3/04; B60B 3/10; B60B 3/14; B60B 3/001; B60B 2900/513; B60B 2360/3416; B60B 2360/104; B60B 2900/112

(57) ABSTRACT

A wheel rim assembly includes a rim defining a rim opening, a wheel disk disposed in the rim opening, a plurality of first fastening members fastening the wheel disk to the rim, and a plurality of second fastening members. The wheel disk includes a center disk defining a center bore that is coaxial with the rim, and a plurality of spokes interconnecting the center disk and the rim. The first fastening members fasten the spokes to the rim such that removal of the first fastening member permits separation of the spoke from the rim. The second fastening members fasten the spokes to the center disk such that removal of the second fastening member permits separation of the spoke from the center disk.

### CROSS-REFERENCE TO RELATED APPLICATION

This application claims priority to Taiwanese Invention Patent Application No. 110109351, filed on Mar. 16, 2021.

### FIELD

The disclosure relates to a wheel, and more particularly to a wheel rim assembly.

### BACKGROUND

Referring to FIG. 1, a conventional wheel rim assembly 1 is shown and includes a 11 defining an inner space 111, a wheel disk 12 disposed in the inner space 111, and a plurality of bolts 13 securing the wheel disk 12 to the rim 11. Although the conventional wheel rim assembly 1 is structurally simple, the external appearance of the conventional wheel rim assembly 1 cannot be changed easily, as the whole wheel disk 12 needs to be replaced in order to change the conventional wheel rim assembly's 1 appearance. Therefore, when the external appearance of the conventional wheel rim assembly 1 is to be changed, a new wheel disk would need to be manufactured, thereby limiting the scope of application of the conventional wheel assembly 1.

### SUMMARY

Therefore, an object of the disclosure is to provide a wheel assembly that can alleviate at least one of the drawbacks of the prior art.

Accordingly, a wheel rim assembly includes a rim that defines a rim opening, a wheel disk that is disposed in the rim opening, and a plurality of first fastening members that fasten the wheel disk to the rim. The wheel disk includes a center disk defining a center bore that is coaxial with the rim, and a plurality of spokes interconnecting the center disk and the rim. Each of the first fastening members fastens removably a respective one of the spokes to the rim such that removal of the first fastening member permits separation of the spoke from the rim. The wheel rim assembly further includes a plurality of second fastening members. Each of the second fastening members fastens removably a respective one of the spokes to the center disk such that removal of the second fastening member permits separation of the spoke from the center disk.

### BRIEF DESCRIPTION OF THE DRAWINGS

Other features and advantages of the disclosure will become apparent in the following detailed description of the embodiments with reference to the accompanying drawings, of which:

FIG. 1 is a side view illustrating a conventional wheel rim assembly;

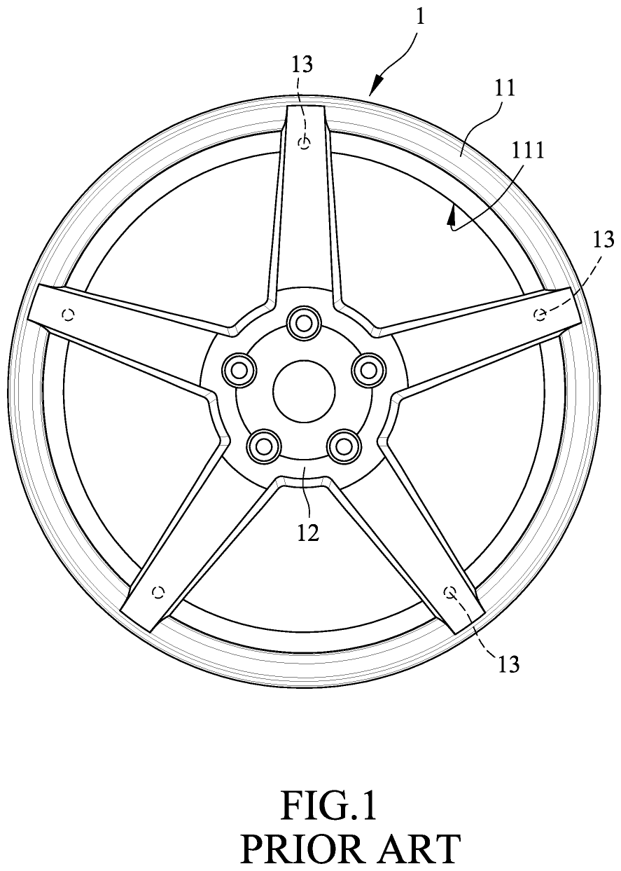

FIG. 2 is a side view illustrating an embodiment of a wheel assembly according to the disclosure;

FIG. 3 is a sectional view of the embodiment with a plurality of securing members and adornment panels being omitted;

FIG. 4 is another side view illustrating the embodiment;

FIG. 5 is a side view of the embodiment with with the adornment panels being omitted; and

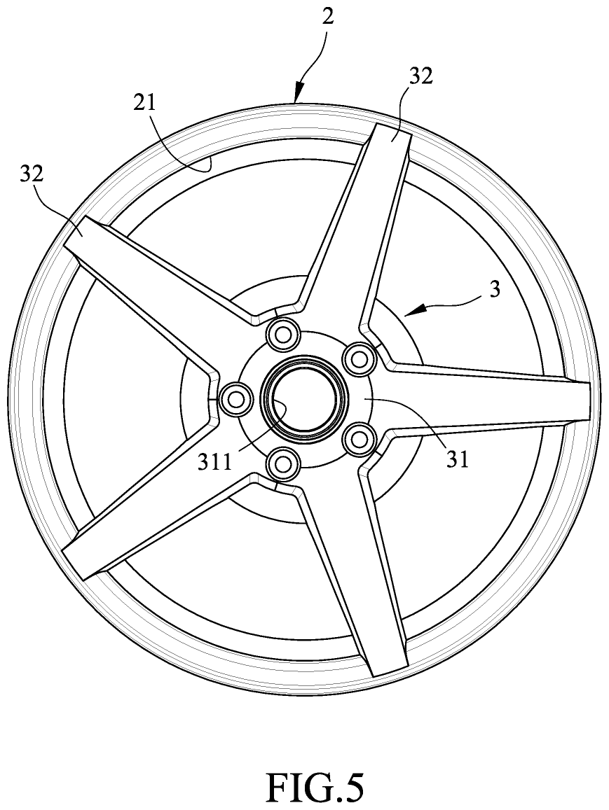

FIG. 6 is a side view illustrating a variation of the embodiment.

### DETAILED DESCRIPTION

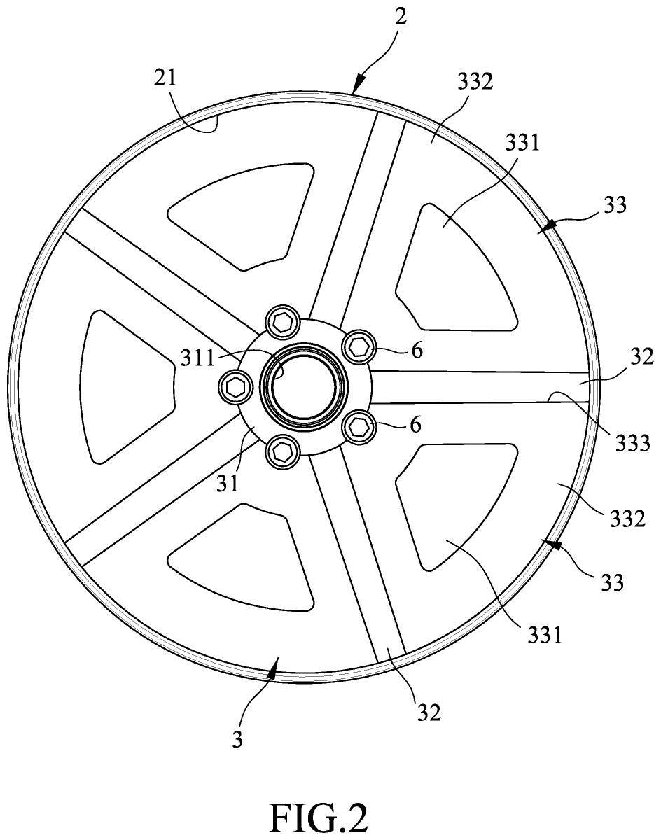

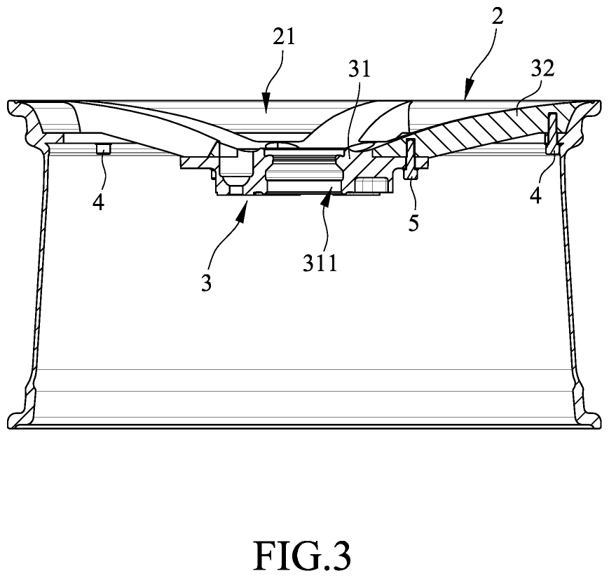

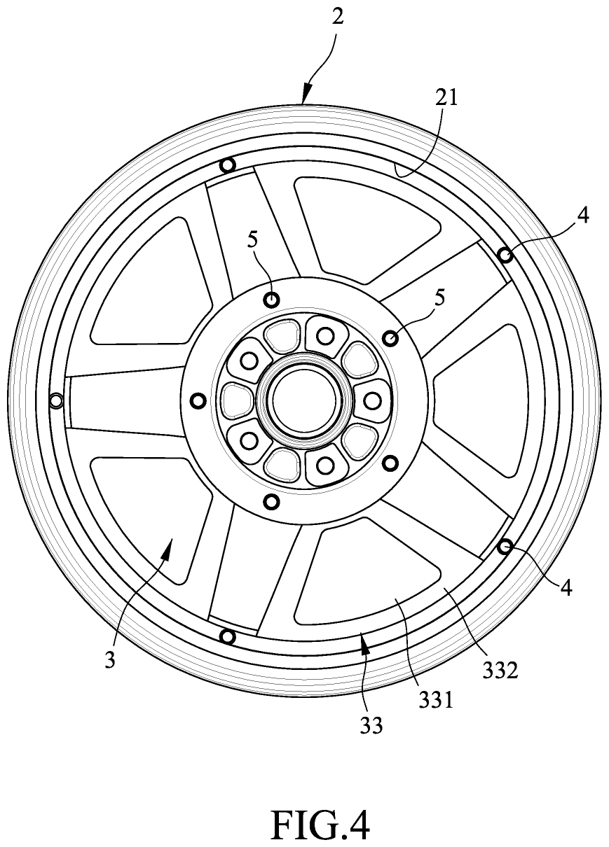

Referring to FIGS. 2, 3 and 4, an embodiment of the wheel rim assembly of the present disclosure is shown. The wheel rim assembly includes a rim 2 that defines an inner rim space. The inner rim space has a rim opening 21. The wheel rim assembly further includes a wheel disk 3 that is disposed in the rim opening 21, and that includes a center disk 31 and a plurality of spokes 32. The center disk 31 defines a center bore 311 that is coaxial with the rim 2. The spokes 32 interconnect the center disk 31 and the rim 2.

The wheel rim assembly further includes a plurality of first fastening members 4 that fasten the wheel disk 3 to the rim 2, and a plurality of second fastening members 5 that fasten the wheel disk 3 to the rim 2. Each of the first fastening members 4 is disposed within the rim 2, extends parallel to a central axis of the rim 2, and fastens removably a respective one of the spokes 32 to the rim 2 such that removal of the first fastening member 4 permits separation of the spoke 32 from the rim 2.

Each of the second fastening members 5 is disposed within the rim 2, extends parallel to the central axis of the rim 2, and fastens removably a respective one of the spokes 32 to the center disk 31 such that removal of the second fastening member 5 permits separation of the spoke 32 from the center disk 31.

The wheel rim assembly further includes a plurality of securing members 6 that extend parallel to the central axis of the rim 2 from an outer side of the wheel disk 3 into the center disk 31 to be secured to the wheel disk 3.

In the present embodiment, the rim 2 made of a carbon fiber composite material. However, in other embodiments of the wheel rim assembly, materials other than carbon fiber composite materials may be used to make the rim 2.

In the present embodiment, the spokes 32 are equiangularly spaced apart on the rim 2, and the wheel disk 3 further includes a plurality of adornment panels 33 arranged along a circumference of the rim 2. In the present embodiment, each of the adornment panels 33 is registered with a space between a respective adjacent pair of the spokes 32, and has a panel body 332 that is formed with a cooling vent 331. Each adjacent pair of the adornment panels 33 define a gap 333 that exposes a respective one of said spokes 32. In the present embodiment, the center disk 31 is made of a metallic material and the spokes 32 are made of a carbon fiber composite material. However, in other embodiments of the wheel rim assembly, other materials may be used, for example, the spokes 32 may be made of an aluminum alloy material.

It should be noted, in other embodiments of the wheel rim assembly the first fastening members 4 may extend through the spokes 32 with the end section fastening into the rim 2, and the second fastening member 5 may extend through the spokes 32 with the end section fastening into the center disk 31.

The removable fastening of the first and second fastening members 4, 5 allows the center disk 31, the rim 2, and the spokes 32 to become removably attached together. In the present embodiment, each of the securing members 6 is bolt-shaped, and has a head portion pressing a respective one of the adornment panels 33 on the center disk 31, thereby securing the adornment panel 33 to the center disk 31.

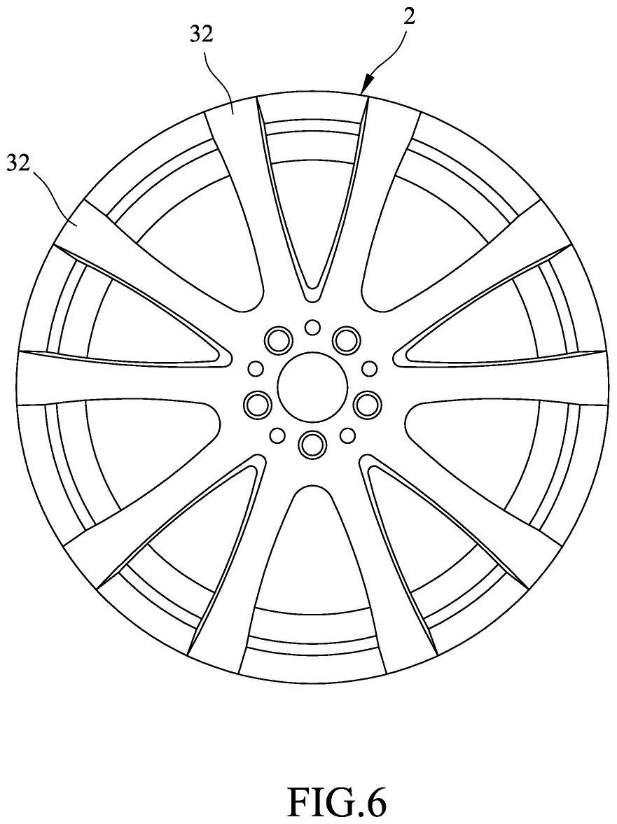

Referring to FIGS. 2, 4 and 6, a user may change the external appearance or the quantity of the spokes 32 and the adornment panels 33 to create different visual combinations the spokes 32 and the adornment panels 33. The visual combinations created by the user can affect the overall appearance of the wheel rim assembly, or the user may opt to omit the adornment panels 33 entirely (as shown in FIG. 6).

Modular design of the wheel rim assembly according to the present disclosure allows the wheel rim assembly to remain usable when the user wishes to change the external design of the vehicle. The cost of tooling parts used for manufacturing the wheel rim assembly may be reduced and the scope of application may be increased.

In summary, a user may change the adornment panels 33 of the wheel disk 3 and the spokes 32 of the rim 2 according to their wishes, thereby creating a different external appearance for the wheel rim assembly. The wheel rim assembly is suitable for modular production with reduced tooling costs. in the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A wheel rim assembly comprising:
a rim that defines a rim opening;
a wheel disk that is disposed in said rim opening, and that includes
a center disk defining a center bore that is coaxial with said rim, and
a plurality of spokes interconnecting said center disk and said rim;
a plurality of first fastening members that fasten. said wheel disk to said rim, each of said first fastening members fastening removably a respective one of said spokes to said rim such that removal of said first fastening member permits separation of said spoke from said rim; and
a plurality of second fastening members, each of said second fastening members fastening removably a respective one of said spokes to said center disk such that removal of said second fastening member permits separation of said spoke from said center disk.

2. The wheel rim assembly as claimed in claim 1, wherein said wheel disk further includes a plurality of adornment panels arranged along a circumference of said rim, each of said adornment panels being registered with a space between a respective adjacent pair of said spokes.

3. The wheel rim assembly as claimed in claim 2, wherein each adjacent pair of said adornment panels define a gap that exposes a respective one of said spokes.

4. The wheel rim assembly as claimed in claim 2, wherein each of said adornment panels has a panel body that is formed with at least one cooling vent.

5. The wheel rim assembly as claimed in claim 2, wherein said wheel rim assembly further comprises a plurality of securing members, each of said securing members securing a respective one of said adornment panels to said center disk.

6. The wheel rim assembly as claimed in claim 1, wherein:
said rim is made of a carbon fiber composite material; and
said center disk is made of a metallic material.

7. The wheel rim assembly as claimed in claim 6, wherein said spokes are made of a carbon fiber composite material.

8. The wheel rim assembly as claimed in claim 6, wherein said spokes are made of an aluminum alloy material.
